(19) United States
(12) Patent Application Publication
(10) Pub. No.: US 2021/0157757 A1
(43) Pub. Date: May 27, 2021

(54) DATA CONVERSION DEVICE AND DATA CONVERSION SYSTEM

(71) Applicant: Cheng Uei Precision Industry Co., Ltd., New Taipei City (TW)

(72) Inventors: Chin Huang Tseng, New Taipei City (TW); Ming Chieh Chen, New Taipei City (TW)

(21) Appl. No.: 17/004,922

(22) Filed: Aug. 27, 2020

Related U.S. Application Data
(60) Provisional application No. 62/940,124, filed on Nov. 25, 2019.

(51) Int. Cl. G06F 13/38; G06F 13/40; G06F 13/42

(52) U.S. Cl. CPC G06F 13/385; G06F 13/387; G06F 13/4282; G06F 13/409; G06F 13/4068

(57) ABSTRACT

A data conversion device is used between a host terminal and an equipment terminal. The equipment terminal is equipped with an RS-232 connection port. The host terminal includes a USB docking port. The data conversion device includes an RS-232 docking port, a micro controller and a USB connection port. The RS-232 connection port is connected with the RS-232 docking port. The RS-232 docking port receives each one-byte data from a RS-232 protocol data packet of the RS-232 connection port in sequence. The micro controller is connected with the RS-232 docking port, after receiving the RS-232 protocol data packet of the RS-232 docking port and setting the RS-232 protocol data packet of the RS-232 docking port into a USB-HID protocol data packet.

### CROSS-REFERENCE TO RELATED APPLICATION

The present application is based on, and claims priority from U.S. provisional patent application No. 62/940,124, filed Nov. 25, 2019, the disclosure of which is hereby incorporated by reference herein in its entirety.

### BACKGROUND OF THE INVENTION

### 1. Field of the Invention

The present invention generally relates to a data conversion device, and more particularly to a data conversion device capable of converting different USB protocols, and a data conversion system including the data conversion device.

### 2. The Related Art

Due to the gradual diversification of technology products with the development of science and technology, different hosts and devices often need to be connected through interconnections among the different hosts and devices to achieve more effective operations.

However, due to the diversification of technological equipments, the different hosts often have different USB data protocols that makes data transmission methods among the different hosts and devices are incompatible, so that different hosts and devices are incapable of being through the interconnections among the different hosts and devices to achieve the more effective operations.

Therefore, it is necessary to provide an innovative data conversion device and a data conversion system, the data conversion system includes the data conversion device, a host terminal and an equipment terminal, so that the host terminal equipped with different USB data protocols may be communicated with the equipment terminal through a data conversion, so that data transmitted between the host terminal and the equipment terminal are made to be compatible to achieve a more effective operation.

### SUMMARY OF THE INVENTION

An object of the present invention is to provide a data conversion device used between a host terminal and an equipment terminal. The equipment terminal applies a RS-232 (Recommended Standard-232) protocol. The equipment terminal is equipped with an RS-232 connection port. The host terminal includes a USB docking port. The data conversion device includes an RS-232 docking port, a micro controller and a USB connection port. The RS-232 connection port of the equipment terminal is connected with the RS-232 docking port. The RS-232 docking port receives each one-byte data from a RS-232 protocol data packet of the RS-232 connection port in sequence. The micro controller is connected with the RS-232 docking port, after receiving the RS-232 protocol data packet of the RS-232 docking port and setting the RS-232 protocol data packet of the RS-232 docking port into a USB-HID protocol data packet, proceed with following operations: collect remaining data in the equipment terminal, confirm whether data is completely collected, if the remaining data exists, return to a previous operation to continue collecting the remaining data, put all the collected data into a buffer area, add an end code into the USB human interface device (USB-HID) protocol data packet, fill up remaining codes of the collected data of the USB human interface device (USB-HID) protocol data packet, so the RS-232 protocol data packet from the equipment terminal is converted into the USB-HID protocol data packet. The USB connection port is connected to the USB docking port of the host terminal, after the USB connection port receives the USB-HID protocol data packet of the micro controller, the USB-HID protocol data packet is transmitted to the USB docking port.

Another object of the present invention is to provide a data conversion device connected between a host terminal and an equipment terminal. The equipment terminal applies a RS-232 (Recommended Standard-232) protocol. The equipment terminal is equipped with an RS-232 connection port. The host terminal includes a USB docking port. The data conversion device includes an RS-232 docking port connected with the RS-232 connection port of the equipment terminal, a micro controller and a USB connection port. The RS-232 docking port is connected with the micro controller. Proceed following operations: receive USB-HID protocol data of the host terminal, sixty-four bytes of the USB-HID protocol data are sequentially taken out by way of using one byte to be a unit for converting the USB-HID protocol data into the RS-232 protocol data, and the RS-232 protocol data is sent to the RS-232 connection port of the equipment terminal by the RS-232 docking port, send an end code, when the micro controller obtains the end code, the RS-232 protocol data is judged to have been completely sent. The USB connection port is connected with the micro controller and is connected to the USB docking port of the host terminal.

Another object of the present invention is to provide a data conversion system. The data conversion system includes a host terminal, an equipment terminal and a data conversion device connected between the host terminal and the equipment terminal. The host terminal includes a USB (Universal Serial Bus) docking port. The equipment terminal applies a RS-232 (Recommended Standard-232) protocol. The equipment terminal is equipped with an RS-232 interface, and an RS-232 connection port connected with the RS-232 interface. The data conversion device includes an RS-232 docking port, a micro controller and a USB connection port. The USB connection port is connected with the micro controller and is connected to the USB docking port of the host terminal. The RS-232 docking port is connected with the micro controller and the RS-232 connection port of the equipment terminal. When data is transmitted from the equipment terminal to the host terminal by the data conversion device, the micro controller receives RS-232 protocol data from the equipment terminal, collect remaining RS-232 protocol data in the equipment terminal, confirm whether the data is completely collected, if the remaining RS-232 protocol data exists, continue collecting the remaining RS-232 protocol data, all the collected RS-232 protocol data is set into a buffer area of a USB-HID protocol data packet, add an end code, the micro controller detects whether each code of the collected data of the buffer area satisfies sixty-four bytes in advance, if one code of the collected data in the buffer area is less than sixty-four bytes, fill up vacant characters of the codes of the collected data with 0x00 until each code of the collected data in the buffer area reaches sixty-four bytes, in this way, the RS-232 protocol data of which each code is one byte is converted into USB-HID protocol data of which each code is sixty-four bytes. When the data is transmitted from the host terminal to the equipment terminal by the data conversion device, receive the transmission data which is USB-HID protocol data from the host terminal, the USB-HID protocol data is converted into the RS-232 protocol data, and the RS-232 protocol data is sent to the RS-232 connection port of the equipment terminal by the RS-232 docking port, sixty-four bytes of the USB-HID protocol data are sequentially taken out by way of using one byte to be a unit for converting the USB-HID protocol data into the RS-232 protocol data, and the RS-232 protocol data is sent to the RS-232 connection port of the equipment terminal by the RS-232 docking port, send the end code, if the end code is without being sent, return to convert each code of the transmission data and send each converted code of the transmission data to the equipment terminal, if the end code is sent and obtained, the RS-232 protocol data is judged to have been completely sent, the USB-HID protocol data in the host terminal is converted into the RS-232 protocol data by the data conversion device to be sent to the equipment terminal.

As described above, the RS-232 protocol data of the equipment terminal and the USB-HID protocol data of the host terminal are converted by the data conversion device, so that the data of the equipment terminal and the host terminal are mutually transmitted and used.

### BRIEF DESCRIPTION OF THE DRAWINGS

The present invention will be apparent to those skilled in the art by reading the following description, with reference to the attached drawings, in which:

FIG. 1 is a system block diagram of a data conversion system in accordance with the present invention, wherein a data conversion device is applied to the data conversion system;

FIG. 2 is a data conversion flow chart showing that data is transmitted from an equipment terminal to a host terminal; and

FIG. 3 is a data conversion flow chart showing that the data is transmitted from the host terminal to the equipment terminal.

### DETAILED DESCRIPTION OF THE PREFERRED EMBODIMENT

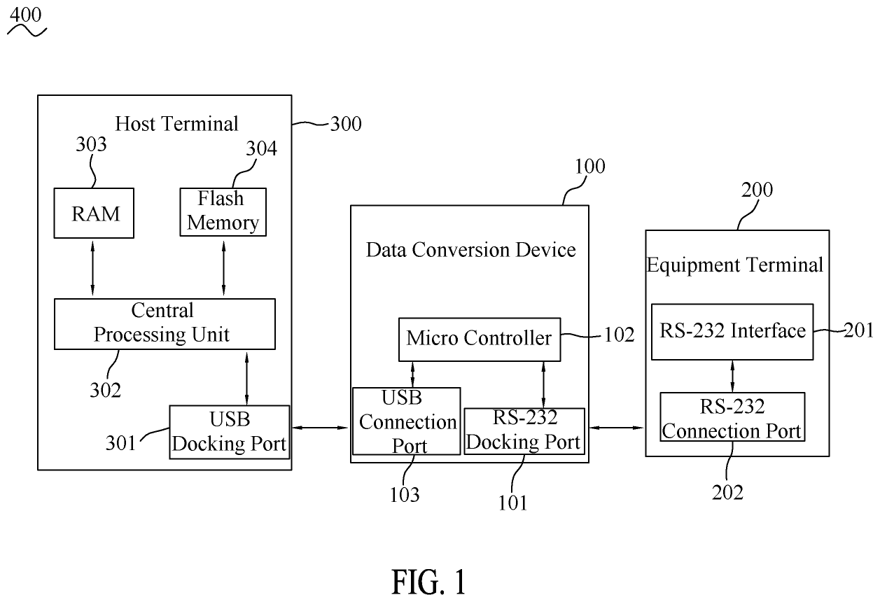

With reference to FIG. 1, a data conversion device 100 and a data conversion system 400 in accordance with the present invention are shown. The data conversion device 100 is a converting and connecting terminal. The data conversion system 400 includes the data conversion device 100, a host terminal 300 and an equipment terminal 200. The data conversion device 100 is connected and used between the host terminal 300 and the equipment terminal 200. The data conversion device 100 is used for converting RS-232 (Recommended Standard-232) protocol data into USB human interface device (USB-HID) protocol data. The data conversion device 100 is also used for converting the USB human interface device (USB-HID) protocol data into the RS-232 (Recommended Standard-232) protocol data.

The equipment terminal 200 applies a RS-232 (Recommended Standard-232) protocol. The equipment terminal 200 is equipped with an RS-232 (Recommended Standard-232) interface 201, and an RS-232 connection port 202 connected with the RS-232 interface 201. The RS-232 is an interface standard of a serial data communication established by American Electronics Industry Association (EIA). A full name of an original number of the RS-232 is EIA-RS-232, and the RS-232 is short for the EIA-RS-232. The data conversion device 100 includes an RS-232 docking port 101, a micro controller 102 (Micro Control Unit, MCU) and a USB connection port 103. The host terminal 300 includes a USB docking port 301, a central processing unit (CPU) 302, a random access memory (RAM) 303 and a flash memory 304. The RS-232 docking port 101 is connected with the micro controller 102 and the RS-232 connection port 202 of the equipment terminal 200.

The host terminal 300 is a data conversion mechanism that transmits the RS-232 protocol data by the USB-HID protocol. The micro controller 102 is connected with the RS-232 docking port 101. The micro controller 102 of the data conversion device 100 is used to proceed with a data conversion between RS-232 protocol and the USB-HID protocol. The central processing unit (CPU) 302 of the host terminal 300 is one of main devices of a computer. Functions of the central processing unit (CPU) 302 is to interpret computer commands and process data in a computer software. The random access memory (RAM) 303 is a memory that directly exchanges the data with the CPU 302. The random access memory (RAM) 303 reads and writes at any time, and a speed of the random access memory (RAM) 303 is quite fast. The random access memory (RAM) 303 is usually used as a temporary data storage medium of an operation system or other running programs. The flash memory 304 is an electronically erasable, programmable and read-only memory form, and the flash memory 304 is a memory which allows to be erased or written repeatedly during an operation of the flash memory 304. This technology of the host terminal 300 is mainly used for general data storages, and exchanging transmission data between computers and other digital products, such as memory cards and flash disks.

The RS-232 connection port 202 of the equipment terminal 200 is connected with the RS-232 docking port 101 of the data conversion device 100, and the USB connection port 103 of the data conversion device 100 is connected with the micro controller 102 and is connected to the USB docking port 301 of the host terminal 300. The RS-232 docking port 101 receives each one-byte datum from a RS-232 protocol data packet of the RS-232 connection port 202 in sequence. After the USB connection port 103 receives a USB-HID protocol data packet of the micro controller 102, the USB-HID protocol data packet is transmitted to the USB docking port 301. The USB connection port 103 sequentially receives each datum of sixty-four bytes sent from the USB-HID protocol data packet of the USB docking port 301 of the host terminal 300.

When the data is transmitted from the equipment terminal 200 to the host terminal 300, the data is transmitted from the equipment terminal 200 to the data conversion device 100 by the RS-232 protocol, and the data conversion device 100 converts the RS-232 protocol data into the USB-HID protocol data, and then the USB-HID protocol data is transmitted to the host terminal 300.

A length of a USB-HID protocol data packet is sixty-four bytes, and a length of the RS-232 protocol data packet is one byte. An encoding length of the USB-HID data packet is sixty-four bytes, an encoding length of a USB-CDC protocol data packet is one byte, and an encoding length of the RS-232 data packet is one byte. Each code of the RS-232 protocol data of the equipment terminal 200 is one byte. Each code of the USB-HID protocol data is sixty-four bytes.

When the host terminal 300 applying the USB-HID protocol and the equipment terminal 200 equipped with the RS-232 interface 201 proceed with a data transmission, the micro controller 102 of the data conversion device 100 will convert the data, after the data is converted in the micro controller 102 of the data conversion device 100 and the converted data is continually transmitted to the corresponding host terminal 300 or the equipment terminal 200.

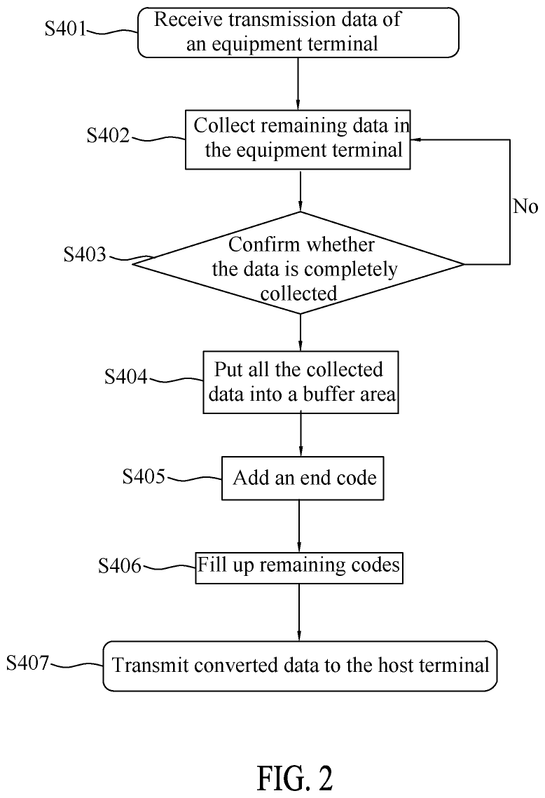

With reference to FIG. 1 and FIG. 2, when the data is transmitted from the equipment terminal 200 to the host terminal 300 by the data conversion device 100, the data will be converted under following data conversion steps, and the following data conversion steps are proceeded in the micro controller 102 of the data conversion device 100.

Step S401: receive the transmission data of the equipment terminal 200. Specifically, in the step S401, the RS-232 protocol data of the equipment terminal 200 of which each code is one byte is received. Furthermore, the micro controller 102 receives the RS-232 protocol data from the equipment terminal 200.

Step S402: collect remaining data in the equipment terminal 200. Specifically, collect remaining RS-232 protocol data in the equipment terminal 200.

Step S403: confirm whether the data is completely collected. If the remaining RS-232 protocol data exists, return to the step S402 of collecting the remaining RS-232 protocol data to continue collecting the remaining data. Specifically, confirm whether the remaining RS-232 protocol data has been completely collected.

Step S404: put all the collected RS-232 protocol data into a buffer area. Specifically, all the collected RS-232 protocol data is set into the buffer area of the USB-HID protocol data packet.

Step S405: add an end code.

Step S406: fill up remaining codes of the collected data. Specifically, the micro controller 102 detects whether each code of the collected data of the buffer area satisfies sixty-four bytes in advance, if one code of the collected data in the buffer area is less than sixty-four bytes, fill up vacant characters of the codes of the collected data with 0x00 until each code of the collected data in the buffer area reaches sixty-four bytes. In this way, the RS-232 protocol data of which each code is one byte is converted into USB-HID protocol data of which each code is sixty-four bytes.

Step S407: transmit the converted data to the host terminal 300. Specifically, the RS-232 protocol data from the equipment terminal 200 is converted into the USB-HID protocol data to be sent to the host terminal 300 for use.

After receiving the RS-232 protocol data packet of the RS-232 docking port 101 and setting the RS-232 protocol data packet of the RS-232 docking port 101 into the USB-HID protocol data packet, proceed with following operations: collect the remaining data in the equipment terminal 200; confirm whether the data is completely collected, if the remaining data exists, return to the previous operation to continue collecting the remaining data; put all the collected data into the buffer area; add the end code into the USB-HID protocol data packet; fill up the remaining codes of the collected data of the USB human interface device (USB-HID) protocol data packet, so the RS-232 protocol data packet from the equipment terminal 200 is converted into the USB-HID protocol data packet. The RS-232 docking port 101 is used for transmitting the converted RS-232 protocol data packet to the RS-232 connection port 202 of the equipment terminal 200.

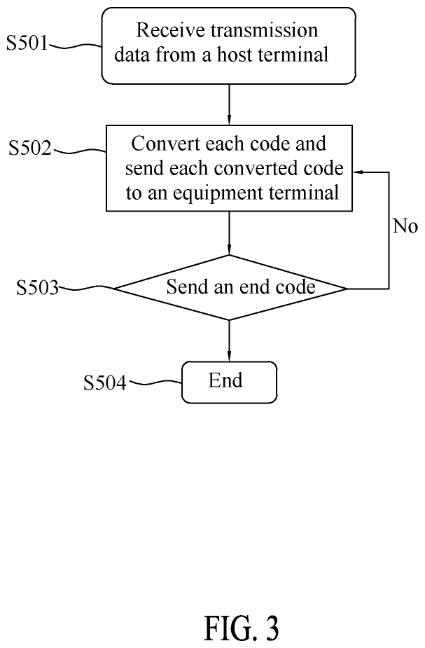

With reference to FIG. 1 to FIG. 3, when the data is transmitted from the host terminal 300 to the equipment terminal 200 by the data conversion device 100, USB-CDC protocol data is transmitted by way of one byte, and the USB-HID protocol data is transmitted by way of sixty-four bytes forming a packet. If the host terminal 300 only supports the USB-HID protocol and has no way of supporting a USB-CDC protocol, the USB-CDC protocol data must be transmitted out by the USB-HID protocol, so the USB-CDC protocol data is transmitted out by the USB-HID protocol. Specifically, the USB-CDC protocol data is sequentially filled in the USB-HID protocol data packet by way of one byte. When the USB-CDC protocol data is completely filled in the USB-HID protocol data packet, the end code is filled in the USB-HID protocol data packet. After the end code is filled in the USB-HID protocol data packet, if the USB-HID protocol data packet still has vacant characters, the vacant characters of the codes of the collected data in the USB-HID protocol data packet are filled with 0x00 until each code of the collected data of the USB-HID protocol data packet reaches sixty-four bytes. The data conversion device 100 proceeds with following operations. The USB-HID protocol data will perform following data conversion steps in the micro controller 102 of the data conversion device 100.

Step S501: receive the transmission data which is the USB-HID protocol data from the host terminal 300. Specifically, receive the USB-HID protocol data of the host terminal 300.

Step S502: convert each code of the transmission data and send each converted code of the transmission data to the equipment terminal 200. Specifically, the USB-HID protocol data is converted into the RS-232 protocol data, and the RS-232 protocol data is sent to the RS-232 connection port 202 of the equipment terminal 200 by the RS-232 docking port 101. The sixty-four bytes of the USB-HID protocol data are sequentially taken out by way of using one byte to be a unit for converting the USB-HID protocol data into the RS-232 protocol data, and the RS-232 protocol data is sent to the RS-232 connection port 202 of the equipment terminal 200 by the RS-232 docking port 101.

Step S503: send the end code. Specifically, in the step S503 of sending the end code, check whether the transmission data is the end code, if the end code is without being sent, return to the step S502 to convert each code of the transmission data and send each converted code of the transmission data to the equipment terminal 200. If the end code is sent and obtained at this time, continue with steps described hereinafter. Specifically, when the micro controller 102 of the data conversion device 100 obtains the end code, the RS-232 protocol data is judged to have been completely sent. Furthermore, after the micro controller 102 obtains the end code, all the characters are 0x00, the data is more accurately judged to have been completely sent.

Step S504: End. In this way, the USB-HID protocol data in the host terminal 300 is converted into the RS-232 protocol data by the data conversion device 100 to be sent to the equipment terminal 200.

As described above, the RS-232 protocol data of the equipment terminal 200 and the USB-HID protocol data of the host terminal 300 are converted by the data conversion device 100, so that the data of the equipment terminal 200 and the host terminal 300 are mutually transmitted and used.

What is claimed is:

1. A data conversion device used between a host terminal and an equipment terminal, the equipment terminal applying a RS-232 (Recommended Standard-232) protocol, the equipment terminal being equipped with an RS-232 connection port, the host terminal including a USB docking port, the data conversion device comprising:
an RS-232 docking port, the RS-232 connection port of the equipment terminal being connected with the RS-232 docking port, the RS-232 docking port receiving each one-byte data from a RS-232 protocol data packet of the RS-232 connection port in sequence;
a micro controller connected with the RS-232 docking port, after receiving the RS-232 protocol data packet of the RS-232 docking port and setting the RS-232 protocol data packet of the RS-232 docking port into a USB-HID protocol data packet, proceeding with following operations: collecting remaining data in the equipment terminal, confirming whether data is completely collected, if the remaining data exists, returning to a previous operation to continue collecting the remaining data, putting all the collected data into a buffer area, adding an end code into the USB human interface device (USB-HID) protocol data packet, filling up remaining codes of the collected data of the USB human interface device (USB-HID) protocol data packet, so the RS-232 protocol data packet from the equipment terminal being converted into the USB-HID protocol data packet; and
a USB connection port connected to the USB docking port of the host terminal, after the USB connection port receives the USB-HID protocol data packet of the micro controller, the USB-HID protocol data packet being transmitted to the USB docking port.

2. The data conversion device as claimed in claim 1, wherein the micro controller detects whether each code of the collected data in the buffer area satisfies sixty-four bytes in advance, if one code of the collected data in the buffer area is less than sixty-four bytes, fill up vacant characters of the codes of the collected data with 0x00 until each code of the collected data in the buffer area reaches sixty-four bytes.

3. A data conversion device connected between a host terminal and an equipment terminal, the equipment terminal applying a RS-232 (Recommended Standard-232) protocol, the equipment terminal being equipped with an RS-232 connection port, the host terminal including a USB docking port, the data conversion device comprising:
an RS-232 docking port connected with the RS-232 connection port of the equipment terminal;
a micro controller, the RS-232 docking port being connected with the micro controller, proceeding following operations: receiving USB-HID protocol data of the host terminal, sixty-four bytes of the USB-HID protocol data being sequentially taken out by way of using one byte to be a unit for converting the USB-HID protocol data into the RS-232 protocol data, and the RS-232 protocol data being sent to the RS-232 connection port of the equipment terminal by the RS-232 docking port, sending an end code, when the micro controller obtains the end code, the RS-232 protocol data being judged to have been completely sent; and
a USB connection port connected with the micro controller and being connected to the USB docking port of the host terminal.

4. The data conversion device as claimed in claim 3, wherein when data is transmitted from the host terminal to the equipment terminal by the data conversion device, USB-CDC protocol data is transmitted by way of one byte, and the USB-HID protocol data is transmitted by way of sixty-four bytes forming a packet, if the host terminal only supports a USB-HID protocol and has no way of supporting a USB-CDC protocol, the USB-CDC protocol data must be transmitted out by the USB-HID protocol, so the USB-CDC protocol data is transmitted out by the USB-HID protocol, the USB-CDC protocol data is sequentially filled in the USB-HID protocol data packet by way of one byte, when the USB-CDC protocol data is completely filled in the USB-HID protocol data packet, the end code is filled in the USB-HID protocol data packet, after the end code is filled in the USB-HID protocol data packet, if the USB-HID protocol data packet still has vacant characters, the vacant characters in the USB-HID protocol data packet are filled with 0x00 until each code of the USB-HID protocol data packet reaches sixty-four bytes.

5. The data conversion device as claimed in claim 3, wherein receive transmission data from the host terminal, convert each code of the transmission data and send each converted code of the transmission data to the equipment terminal, check whether the transmission data is the end code, if the end code is without being sent, return to convert each code of the transmission data and send each converted code of the transmission data to the equipment terminal, if the end code is sent and obtained, all characters are 0x00.

6. A data conversion system, comprising:
a host terminal including a USB (Universal Serial Bus) docking port;
an equipment terminal applying a RS-232 (Recommended Standard-232) protocol, the equipment terminal being equipped with an RS-232 interface, and an RS-232 connection port connected with the RS-232 interface; and
a data conversion device connected between the host terminal and the equipment terminal, the data conversion device including an RS-232 docking port, a micro controller and a USB connection port, the USB connection port being connected with the micro controller and being connected to the USB docking port of the host terminal, the RS-232 docking port being connected with the micro controller and the RS-232 connection port of the equipment terminal,
wherein when data is transmitted from the equipment terminal to the host terminal by the data conversion device, the micro controller receives RS-232 protocol data from the equipment terminal, collect remaining RS-232 protocol data in the equipment terminal, confirm whether the data is completely collected, if the remaining RS-232 protocol data exists, continue collecting the remaining RS-232 protocol data, all the collected RS-232 protocol data is set into a buffer area of a USB-HID protocol data packet, add an end code, the micro controller detects whether each code of the collected data of the buffer area satisfies sixty-four bytes in advance, if one code of the collected data in the buffer area is less than sixty-four bytes, fill up vacant characters of the codes of the collected data with 0x00 until each code of the collected data in the buffer area reaches sixty-four bytes, in this way, the RS-232 protocol data of which each code is one byte is converted into USB-HID protocol data of which each code is sixty-four bytes, and
wherein when the data is transmitted from the host terminal to the equipment terminal by the data conversion device, receive the transmission data which is USB-HID protocol data from the host terminal, the USB-HID protocol data is converted into the RS-232 protocol data, and the RS-232 protocol data is sent to the RS-232 connection port of the equipment terminal by the RS-232 docking port, sixty-four bytes of the USB-HID protocol data are sequentially taken out by way of using one byte to be a unit for converting the USB-HID protocol data into the RS-232 protocol data, and the RS-232 protocol data is sent to the RS-232 connection port of the equipment terminal by the RS-232 docking port, send the end code, if the end code is without being sent, return to convert each code of the transmission data and send each converted code of the transmission data to the equipment terminal, if the end code is sent and obtained, the RS-232 protocol data is judged to have been completely sent, the USB-HID protocol data in the host terminal is converted into the RS-232 protocol data by the data conversion device to be sent to the equipment terminal.

7. The data conversion system as claimed in claim 6, wherein when the data is transmitted from the host terminal to the equipment terminal by the data conversion device, USB-CDC protocol data is transmitted by way of one byte, and the USB-HID protocol data is transmitted by way of sixty-four bytes forming a packet, if the host terminal only supports a USB-HID protocol and has no way of supporting a USB-CDC protocol, the USB-CDC protocol data must be transmitted out by the USB-HID protocol, so the USB-CDC protocol data is transmitted out by the USB-HID protocol, the USB-CDC protocol data is sequentially filled in the USB-HID protocol data packet by way of one byte, when the USB-CDC protocol data is completely filled in the USB-HID protocol data packet, the end code is filled in the USB-HID protocol data packet, after the end code is filled in the USB-HID protocol data packet, if the USB-HID protocol data packet still has vacant characters, the vacant characters in the USB-HID protocol data packet are filled with 0x00 until each code of the USB-HID protocol data packet reaches sixty-four bytes.

8. The data conversion system as claimed in claim 6, wherein after the micro controller obtains the end code, all characters are 0x00, the data is more accurately judged to have been completely sent.

9. The data conversion system as claimed in claim 6, wherein the USB connection port sequentially receives each datum of sixty-four bytes sent from the USB-HID protocol data packet of the USB docking port of the host terminal.
